(19) United States
(12) Patent Application Publication
(10) Pub. No.: US 2025/0285614 A1
(43) Pub. Date: Sep. 11, 2025

(54) Use Of Modulation Spectrums In Automatic Speech Recognition Models

(71) Applicant: Oracle International Corporation, Redwood Shores, CA (US)

(72) Inventors: Vivek Tyagi, Dublin (IE); Trideba Padhi, Rennes (FR); Astik Biswas, Kolkata (IN); Amin Abdaoui, Toulouse (FR); Abdelmoumene Boumadane, Paris (FR); Stephane Brice Peillon, Lannion (FR); Gildas Bleas, Rennes (FR); Serge Le Huitouze, Rennes (FR)

(73) Assignee: Oracle International Corporation, Redwood Shores, CA (US)

(21) Appl. No.: 18/778,230

(22) Filed: Jul. 19, 2024

Related U.S. Application Data
(60) Provisional application No. 63/563,159, filed on Mar. 8, 2024.

(51) Int. Cl. G10L 15/16; G10L 25/18

(52) U.S. Cl. CPC G10L 15/16; G10L 25/18

(57) ABSTRACT

Techniques for speech recognition models using modulation spectrum are disclosed herein. A modulation spectrum is generated from time series data output of an encoder layer of a speech recognition model and used as input into a decoder layer of the speech recognition model to improve accuracy of the model such as for recognizing subword units. The modulation spectrum is determined by applying a convolution filter to the output of the encoder layer of the speech recognition model. The time series data and/or the modulation spectrum can be normalized. A rectified linear unit activation function can be applied to the output of the convolution filter. The output of the encoder layer may be residually connected to the output of the rectified linear unit activation function prior to being input into the decoder layer.

### INCORPORATION BY REFERENCE; DISCLAIMER

Each of the following applications are hereby incorporated by reference: Application No. 63/563,159 filed on filed Mar. 8, 2024. The applicant hereby rescinds any disclaimer of claims scope in the parent application(s) or the prosecution history thereof and advises the USPTO that the claims in the application may be broader than any claim in the parent application(s).

### TECHNICAL FIELD

The present disclosure relates to the use of modulation spectrums in Automatic Speech Recognition (ASR) models. In particular, the present disclosure relates to providing a modulation spectrum of an encoder layer output to a decoder layer of an ASR to improve the accuracy of the model.

### BACKGROUND

Automatic Speech Recognition (ASR) is a technology that converts spoken language into written text. It involves the use of algorithms and models to analyze audio signals and transcribe them into text. ASR has various applications, including voice assistants, transcription services, and voice-activated systems.

Training ASR models can be expensive and may require vast amounts of labeled data, posing further costs and challenges to obtain diverse and representative datasets. Improving trained ASR models is difficult due to the variety of challenges involved in speech recognition. For example, ASR models can struggle with background noise, accents, and variations in speaking styles, making them less robust in real-world conditions.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates an example system for ASR using modulation spectrum features in accordance with one or more embodiments;

FIG. 2 illustrates an example set of operations for ASR using modulation spectrum features in accordance with one or more embodiments;

FIGS. 3A-3I illustrate an example use of modulation spectrum in ASR in accordance with one or more embodiments; and

FIG. 4 is a block diagram that illustrates a computer system where ASR using modulation spectrum may be implemented in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVER VIEW
2. MODULATION SPECTRUM-BASED ASR ARCHITECTURE
3. USING CONVOLUTION FILTERS TO GENERATE MODULATION SPECTRUMS FOR ASR MODELS
4. MODULATION SPECTRUM IN ASR
5. NORMALIZATION, CONVOLUTION FILTRATION, NONLINEARIZATION, AND RESIDUALIZATION TECHNIQUES
6. COMPUTER NETWORKS AND CLOUD NETWORKS FOR MODULATION SPECTRUM-BASED ASR
7. MICROSERVICE APPLICATIONS FOR MODULATION SPECTRUM-BASED ASR
8. HARDWARE OVERVIEW
9. MISCELLANEOUS; EXTENSIONS; OTHER CONSIDERATIONS

### 1. General Overview

One or more embodiments implement a modulation spectrum for an ASR model in various contexts to improve speech recognition. Aspects of this disclosure may be used to increase accuracy of speech recognition models, without significant additional cost, for example, by determining a modulation spectrum based on an output of an encoder of an ASR model and inputting the modulation spectrum to a decoder of the ASR model. The system may include a normalization layer to normalize the output of the encoder and/or the input to the decoder of the ASR model. Furthermore, the system may apply a ReLU nonlinearizer to generate the input of the decoder.

While this General Overview section provides a general overview, additional embodiments and related combinations of features may be described in this Specification and/or recited in the claims outside of this General Overview section.

### 2. Modulation Spectrum-Based ASR Architecture

In various situations, a variety of models can be used to model speech to identify spoken words contained in audio data. Such models include Hidden Markov Models (HMMs), Neural Networks including Deep Neural Networks (DNNs), Recurrent Neural Networks (RNNs), Long Short-Term Memory (LSTM) networks, Convolutional Neural Networks (CNNs) hybrid models, or other models. These models learn complex patterns and representations from large amounts of data. ASR systems can use hybrid models that combine the strengths of the models in various ways. However, traditional applications of these models fail to adequately account for signal processing information that can be determined from a modulation spectrum. Thus, modulation spectrum can be used to enhance or improve these or similar models.

The modulation spectrum may refer to a representation of the variations in amplitude of an audio signal over time. Using different time frames, frequencies, and/or filters, various useful features of a signal can be extracted. The features can be encoded into time series data from which a modulation spectrum can be extracted. The modulation spectrum can assist models in decoding sound data.

Various encoder/decoder-based models can be improved using modulation spectrum. By extracting a modulation spectrum from time series data generated from an output of an encoder of the model and processed via normalization, ReLU nonlinearity, residual connection, and/or convolution filtration, modulation spectrum information becomes usable by a decoder of such models, improving accuracy of the decoded result. The information in the modulation spectrum may not otherwise be apparent to the decoder; thus, making the modulation spectrum information available improves the accuracy of the speech recognition models. In this way, the normalization process and convolution filter process applied to extract the modulation spectrum features facilitate the model being able to use signal information not otherwise accessible to traditional modelling systems.

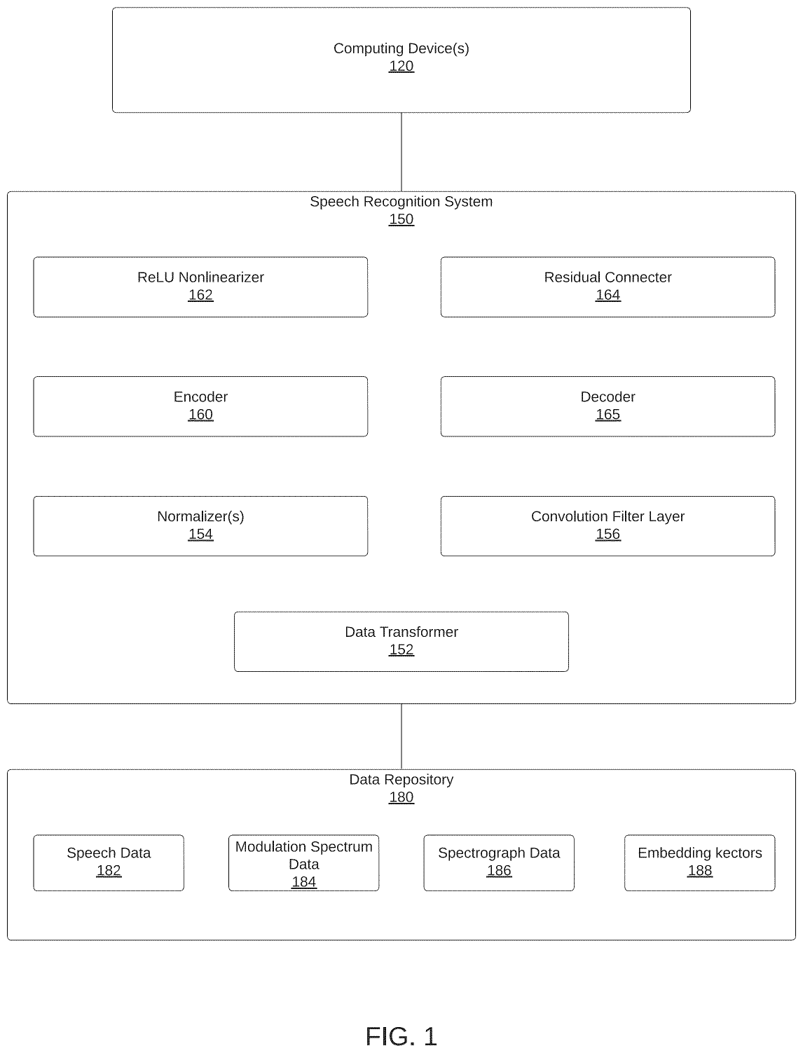

FIG. 1 illustrates an example architecture 100 for ASR using modulation spectrum features in accordance with one or more embodiments. As illustrated in FIG. 1, system 100 includes one or more computing devices 120, a speech recognition system 150, and a data repository 180. In various embodiments, the architecture 100 may include more or fewer components than the components illustrated in FIG. 1. The components illustrated in FIG. 1 may be local to or remote from each other. The components illustrated in FIG. 1 may be implemented in software and/or hardware. Components may be distributed over multiple applications and/or machines. Multiple components may be combined into one application and/or machine. Operations described with respect to one component may instead be performed by another component.

Additional embodiments and/or examples relating to computer networks are described below in Section 5, titled “Computer Networks and Cloud Networks for modulation spectrum-based ASR”.

In FIG. 1, various types of computing devices, such as a personal computer, smart phone, or the like, are used to access the speech recognition system 150, such as via a networked connection to the system 150. The speech recognition system 150 includes a data transformer 152, one or more normalizers 154, a convolution filter layer 156, an encoder 160, a decoder 165, a Rectified Linear Unit (“ReLU”) nonlinearizer 162, and a residual connector 164.

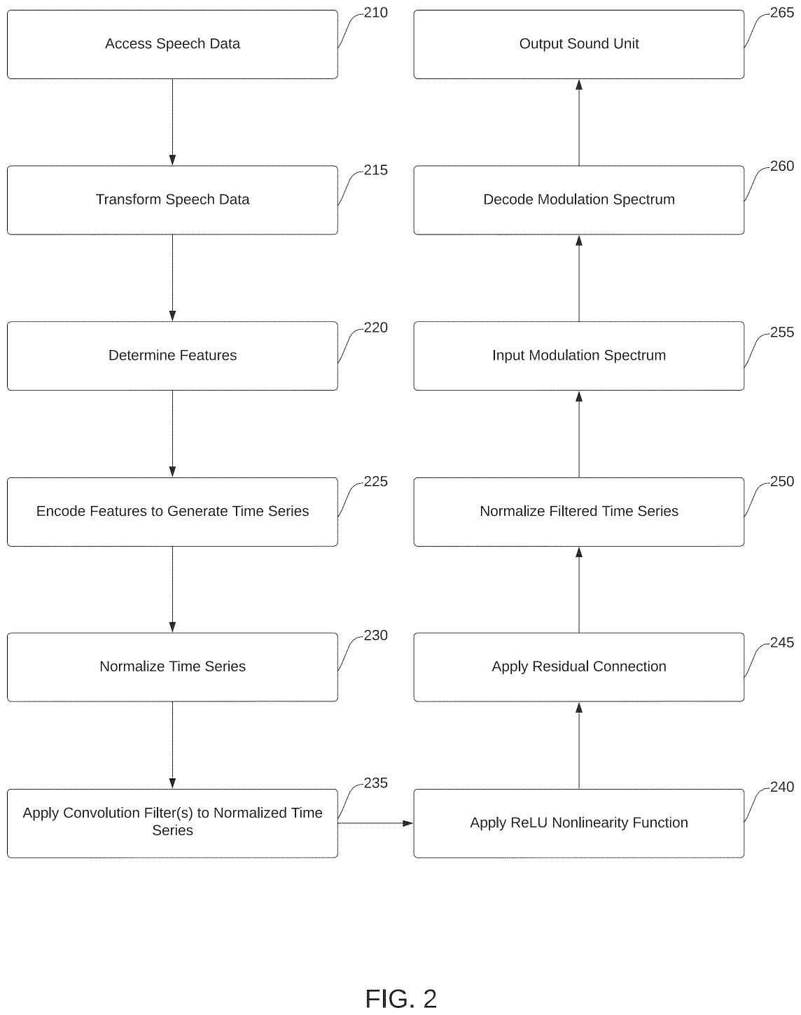

In one or more embodiments, the speech recognition system 150 refers to hardware and/or software configured to perform operations described herein for speech recognition. Examples of operations for ASR using modulation spectrum features are described below with reference to FIG. 2. In an embodiment, the speech recognition system 150 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

The data transformer 152 is a module responsible for preprocessing and transforming input into the speech recognition system 150. The data transformer 152 may perform operations to capture relevant features for speech recognition by converting or transforming raw audio signals and/or spectrograms (such as linear, logarithmic, constant-Q, short time Fourier transform [“STFT”], Mel-frequency cepstral coefficients [“MFCCs”], or other spectrograms). This preprocessing step helps in extracting discriminative information from the input audio and prepares the data for further processing in the neural network.

A short time Fourier transform is an example of a transformation that may be applied to speech data or other sound or waveform data. In examples disclosed herein, data from the data repository 180 is transformed via STFT operations prior to being encoded at an encoder 160 to generate a time-frequency representation of a signal, capturing how the frequency content changes over a series of time frames. STFT employs windowing functions to analyze short segments of a signal, making it effective for processing signals that exhibit both local and non-local behavior.

One or more normalizers 154 are used for standardizing or normalizing input data to ensure consistency and improve the convergence of the neural network during training. Normalization techniques may include mean subtraction and variance scaling to bring the input features to a common scale, aiding in the stability and efficiency of the learning process. This step helps mitigate issues related to varying signal amplitudes and contributes to the overall robustness of the speech recognition system.

The convolution filter layer 156 employs convolutional filters to extract features from audio data encoded by the encoder 160. These filters consist of a convolution matrix that performs a series of matrix operations by “sliding” or iterating operations between the convolution matrix and consecutive subsets of the audio data matrix. This filtration facilitates capturing local patterns, learning representations of and relationships between the subsets of the audio data matrix, and improving speech recognition. The convolution filter process results in a modulation spectrum for the encoded audio data.

Various speech models may be deployed by the speech recognition system. Such models may use different types of neural networks. Features of the encoder 160 and the decoder 165 may apply to various encoder/decoder models. In the speech recognition system 150, the encoder 160 receives sound data that may be transformed sound data and encodes the data into a plurality of values. The values include a plurality of values for each of one or more time frames t and a number of features for the one or more time frames equal to a dimensionality k for the one or more time frames. Decoders are used in speech recognition systems to generate a sequence of linguistic units, such as phonemes, words, or word subunits. Decoder 165 decodes sound data. Decoder 165 decodes encoded time series data that has been encoded by the encoder 160. The decoder 165 may also decode encoded time series data that has been normalized by the normalizer(s) 154, nonlinearized by the ReLU nonlinearizer 162, or residually connected to another layer output by the residual connector 164. The decoder 165 outputs a transcript of sound, word, character units, or the like.

The ReLU nonlinearizer 162 introduces non-linearity into an input to provide a nonlinearized output. The ReLU nonlinearizer 162 nonlinearizes encoded time series data output that may have been filtered by applying nonlinearization to modulation spectrum data extracted via the convolution filter layer 156. This non-linearity component facilitates capturing complex relationships in the data and enhances learning and performance of the speech recognition system. Non-linearity helps to mitigate issues related to vanishing gradients in deep learning.

The residual connector 164 performs operations related to the incorporation of residual connections between layers, such as the normalizer(s) 154 or convolution filter layer(s) 156. Residual connections between layers are used to connect an output of a layer to an output of a previous layer. Residual connections, especially in combination with nonlinearization, mitigate issues related to vanishing gradients.

The data repository 180 stores data accessed by and/or generated by the speech recognition system 150. Example data types included in repository 180 are speech data 182, modulation spectrum data 184, spectogram data 186, and embedding vectors 188.

Speech data 182 includes digitized audio recordings or signals, for example, digital recordings that capture spoken language, typically represented as a time-varying waveform. In the context of machine learning and signal processing, speech data is analyzed and processed to extract features for ASR tasks.

A Modulation Spectrum 184 includes representations of spectral variations in a signal over time that characterize how the amplitude or frequency components of a signal change dynamically. Modulation spectrum is generated from processed sound data to capture different features such as pitch, intonation, and/or other aspects. Modulation spectrum extraction can be used to define hidden layers in an audio signal in the modulation spectrum. In the case of speech, different spectral components corresponding to different phonemes vary with time because humans speak different phonemes in a word. While STFT or other techniques capture the short-term spectrum, modulation spectrum captures the rate of change of these short time spectra; this improves phoneme recognition in many systems, including decoder-encoder based models.

Spectrogram Data 186 includes one or more digitized visual representations of spectrums of variations of frequencies in a signal with respect to time. Spectrogram data is a 2D representation, where the x-axis represents time, the y-axis represents frequency, and the intensity of color or shading indicates the amplitude of the corresponding frequency at a given time. Spectrogram data is used for feature extraction such as by providing a time-frequency representation of speech signals.

Embedding vectors 188 are numerical representations of objects or concepts in a continuous vector space. Embedding vectors are used to represent sound data in vector form. They are used in various learning tasks and enable machines to understand and work with textual information more effectively.

In embodiments, a data repository 180 is any type of storage unit and/or device (e.g., a file system, database, collection of tables, or any other storage mechanism) for storing data. Further, a data repository 180 may include multiple different storage units and/or devices. The multiple different storage units and/or devices may or may not be of the same type or located at the same physical site. Further, a data repository 180 may be implemented or executed on the same computing system as the computing device 120 and/or the speech recognition system 150. Additionally, or alternatively, a data repository 180 may be implemented or executed on a computing system separate from the computing device 120 and the speech recognition system 150. The data repository 180 may be communicatively coupled to the speech recognition system 150 via a direct connection or via a network. Information used, modified, and/or updated the speech recognition system 150 may be implemented across any of components within the system 100. However, this information is illustrated within the data repository 180 for purposes of clarity and explanation.

In one or more embodiments, an interface refers to hardware and/or software configured to facilitate communication between a user and a system. In FIG. 1, an interface may be used to facilitate communication between the one or more client devices 120 and the speech recognition system 150. An interface as used herein may refer to a programmatic endpoint of a Graphical User Interface that renders user interface elements and receives input via user interface elements.

In various embodiments, different components of such an interface are specified in different languages. The behavior of user interface elements is specified in a dynamic programming language such as JavaScript. The content of user interface elements is specified in a markup language, such as hypertext markup language (HTML) or XML User Interface Language (XUL). The layout of user interface elements is specified in a style sheet language such as Cascading Style Sheets (CSS). Alternatively, interfaces may be specified in one or more other languages, such as Java, C, or C++.

### 3. Using Convolution Filters to Generate Modulation Spectrums for ASR Models

FIG. 2 illustrates an example set of operations 200 for using convolution filters to generate modulation spectrums in accordance with one or more embodiments. One or more operations illustrated in FIG. 2 may be modified, rearranged, or omitted. Accordingly, the particular sequence of operations illustrated in FIG. 2 should not be construed as limiting the scope of one or more embodiments. In embodiments, the set of operations 200 may be performed by a system, which may be speech recognition system 150.

In one or more embodiments, the system accesses speech data (Operation 210). For example, a speech recognition system can access data in a data repository such as by accessing audio files containing a recorded conversation or spoken word. Alternatively, audio data may be provided directed from a client device to the speech recognition system. The speech recognition system may detect the speech data using a sensor.

In an embodiment, the system transforms speech data (Operation 215). Various operations can be used to transform waveforms, including sound or speech data. The system applies a STFT to speech data, including raw speech data and/or processed data. Such transformations may result in a spectrogram representation. The steps involved in performing a STFT may include the following:
1. Segmentation of the Signal: Divide the input signal into short, overlapping segments or windows. The choice of window length and overlap depends on the characteristics of the signal and the desired time-frequency resolution. Common window functions include Hamming, Hanning, or Gaussian windows.
2. Windowing: Multiply segments by a chosen window function. This process helps mitigate spectral leakage, a phenomenon that occurs when the frequency content of a signal extends beyond the boundaries of the analysis window. The windowing function helps reduce the impact of this phenomenon.
3. Application of Fourier Transform: Apply the Fourier Transform to the windowed segments. The Fourier Transform converts the signal from the time domain to the frequency domain, providing information about the amplitude and phase of different frequency components.
4. Repeat for Overlapping Windows: Slide the window along the signal with a specified overlap, typically 50%, but it can vary. This overlapping allows for a smoother transition between consecutive windows and provides better time resolution in the resulting spectrogram.
5. Magnitude Calculation: Calculate the magnitude of the Fourier Transform for each windowed segment. This is often done by taking the absolute value of the complex result obtained from the Fourier Transform. The magnitude represents the amplitude of different frequency components.
6. Time-Frequency Representation: The result is a time-frequency representation of the signal, commonly known as a spectrogram. The x-axis represents time, the y-axis represents frequency, and the color or intensity represents the amplitude of the corresponding frequency component. Darker regions in the spectrogram indicate higher energy or amplitude.

The system determines features of the speech data (Operation 220). Sound data, such as raw sound data or spectrograms, can be analyzed by the system to extract features. Such features can be assigned a value over a time frame of the sound data. Many features can be assigned a value for a time frame. The number of features of a time frame may be referred to as the dimensionality of the time frame. Spectograms can be analyzed for various features, such as frequency content, time-frequency patterns, spectral envelopes, MFCCs, Chroma features, or other features of sound data.

The system encodes extracted features of speech data to generate encoded time series data (Operation 225). Various neural network encoders can be used to encode speech data. Extracted features are compressed into encoded time series data representing encoded speech features of input speech data (i.e., an input spectrogram). The output of the encoder is the encoded representation; this may be referred to as a time series or time series data. An encoded time series captures the essential features of the input spectrogram in a more condensed form. Each element in the time series corresponds to a specific aspect or feature learned by the network during the encoding process.

The system normalizes encoded time series data (Operation 230). Normalizing encoded time series data may include, for example, scaling values using a mean and standard deviation, ensuring consistency in the input data. Normalizing encoded time series data may further include mapping a set of original values into a corresponding value between a particular range of values (e.g., a range between 0 and 1).

The system applies one or more convolution filters to the normalized, encoded time series data (Operation 235). The one or more convolutional filters are applied to capture local patterns in the normalized time series data, resulting in a modulation spectrum. A convolution filter, or kernel, is a matrix used in the process of convolution. Convolution is a mathematical operation that combines two functions to produce a third function. In the context of signal or speech processing, convolution filters are applied to data to perform various operations. One or more convolution filters are applied to speech data, such as in the form of normalized time series data, to perform modulation spectrum extraction. A convolution filter can have different sizes or widths corresponding to a number of rows, columns, and/or cells in the filter matrix. The convolution filter(s) are used to capture patterns or features of speech data.

In embodiments of this disclosure, a convolution filter can be applied to a matrix of normalized values to extract a modulation spectrum from the matrix. The convolution filter is applied by sliding the convolution filter to generate dot product values corresponding to the dot products of rows of the convolution matrix and rows of the matrix of normalized values. At the various positions, the filter performs a dot product with the local values in the normalized time series data. This process reveals local patterns that match characteristics encoded in the filter. In embodiments, zero padding is used, such as by using a zero value, where the width of the convolution matrix extends past the matrix of normalized values. The convolution filter(s) are used to perform a convolution operation on the matrix of normalized values.

A convolution operation includes the following steps: Place the convolutional filter at a corner of the matrix of normalized values. Perform element-wise multiplication between the filter and the portion of the input matrix it covers. Sum up the results of the element-wise multiplication to obtain a single value. Slide the convolution filter by a certain stride (step size) and repeat the multiplication and summation process. Continue sliding the filter until the end of the row (or column), then to the next row (or column) and repeat the process. The result is a type of feature map known as a modulation spectrum.

The system applies a ReLU nonlinearity function (Operation 240). ReLU functions are applied to introduce non-linearity, allowing the network to model complex relationships in the data. The ReLU function is used by applying a mathematical operation to the values input into the function. The ReLU function is defined as follows: f(x)=max(0,x).

In this function, if the input x is positive, the output is equal to the input (f(x)=x). However, if the input is negative, the output becomes zero. This, the ReLU function introduces nonlinearity by transforming negative inputs to zero, while leaving positive inputs unchanged. This piecewise linearity facilitates neural networks' learning and representation of non-linear relationships.

The system applies a residual connection (Operation 245). A residual connection is added to facilitate the flow of information through the network, aiding in the training of deep models for improved speech recognition performance. In an example, a residual connection is applied by summing normalized encoded time series data with a result of filtering and non-linearizing the time series data (i.e., with a nonlinearized modulation spectrum of the time series data).

The system normalizes the filtered time series data (Operation 250). The system applies normalization techniques to the filtered time series data, maintaining stable input conditions for subsequent layers in the neural network. Normalization techniques are described further in the example embodiments below. Normalization can be applied to the modulation spectrum and/or the modulation spectrum with a residual connection added.

The system inputs the modulation spectrum into a decoder (Operation 255). The modulation spectrum, derived from the filtered and normalized time series data, is fed into a neural network decoder. This contrasts with traditional decoder input that may have come from an encoder without application of various operations disclosed herein.

The system decodes the modulation spectrum using the decoder (Operation 260). The decoder processes the modulation spectrum, reconstructing the encoded features into a representation suitable for sound unit recognition. Such a representation can include a transcript of words, letters, sounds, or the like.

The system outputs a sound unit, such as a word, character, or sub word unit (Operation 265). The system produces the recognized sound unit, such as a word or phoneme, based on sound data accessed by the system. The system provides output in the form of a transcript. The transcript is displayed on a display of a computing device, stored in computer memory, and/or transmitted electronically to another computing device or to a data repository. The system can process an entire recording; thus, operations 200 can be used to complete a speech recognition task for an input speech data recording.

### 4. Modulation Spectrum in ASR

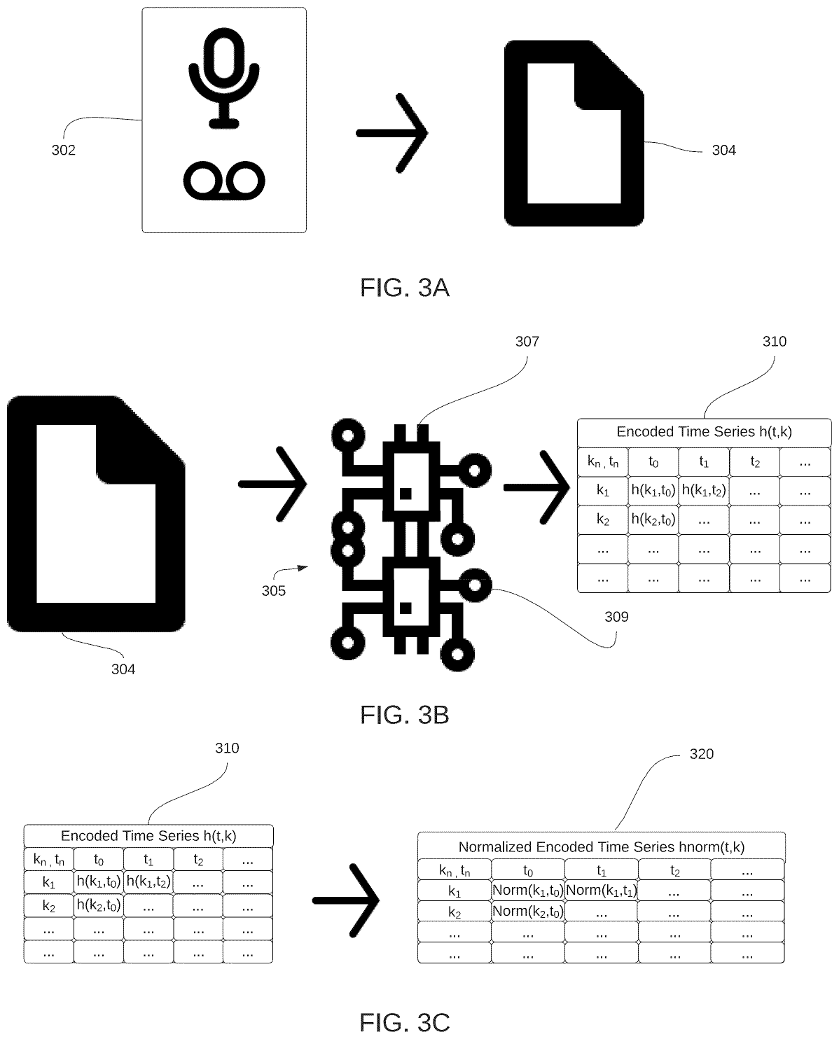

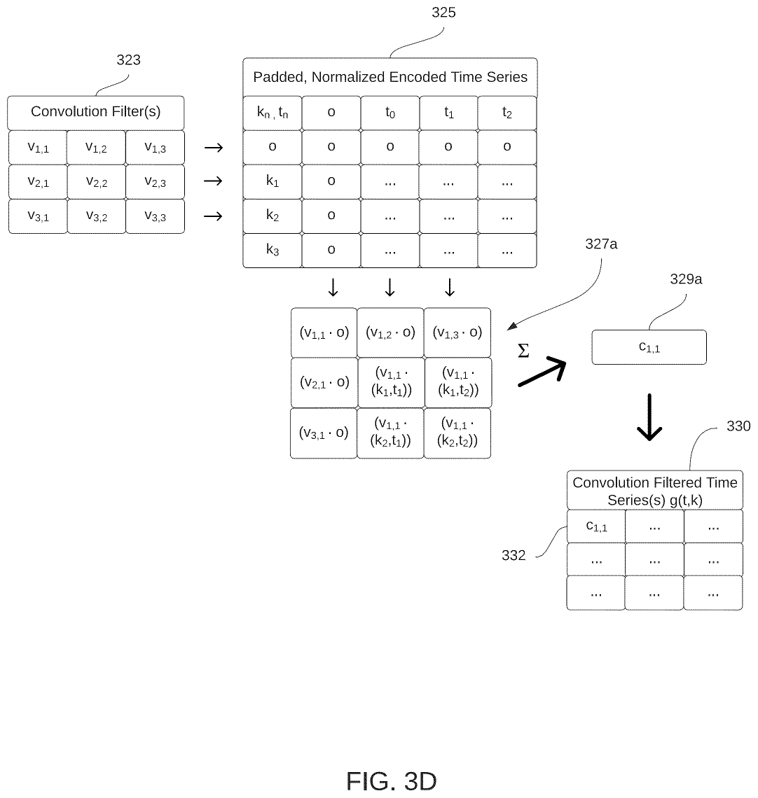

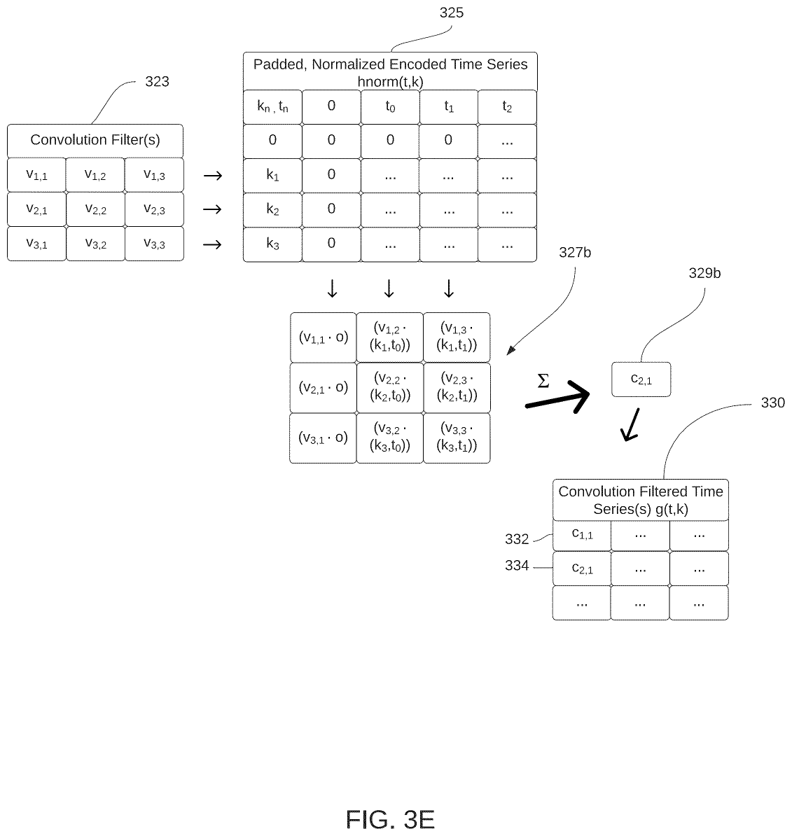

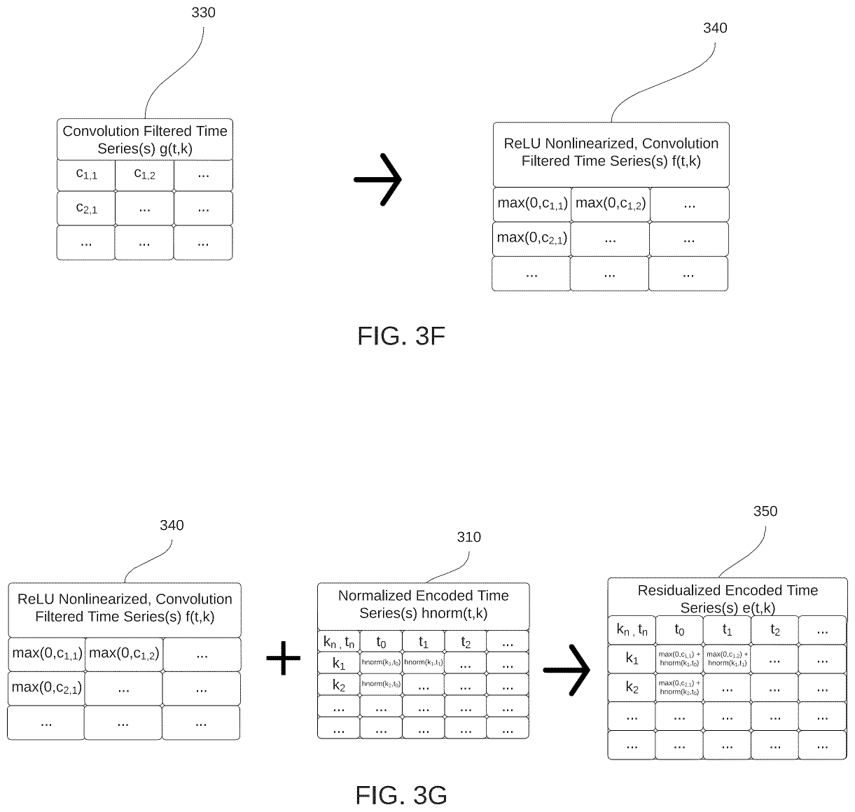

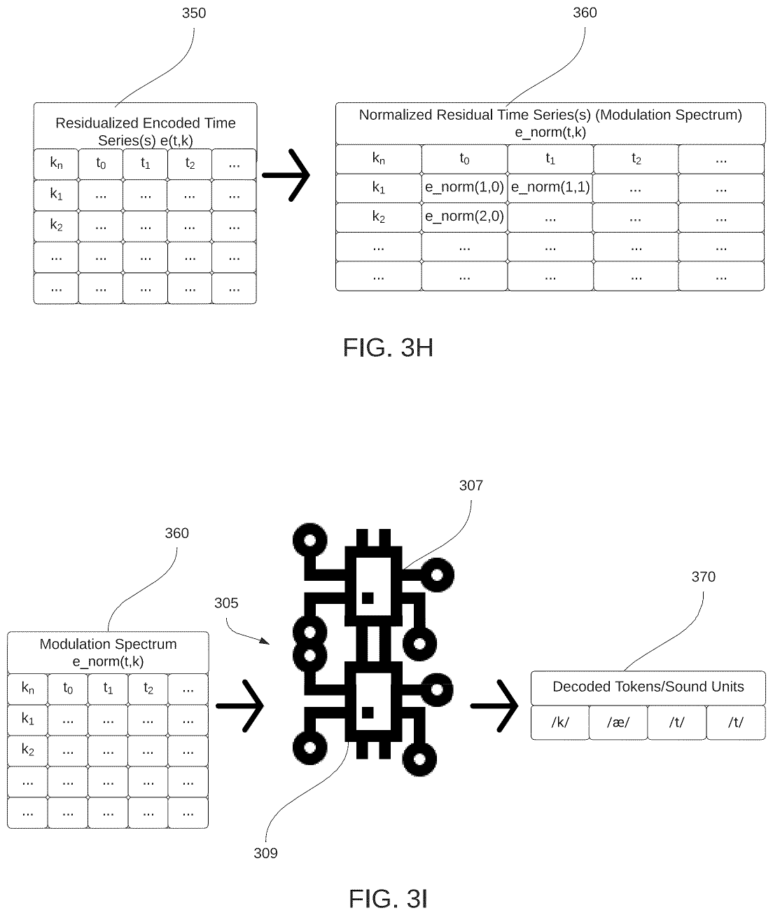

FIGS. 3A-3I illustrate an example use of modulation spectrum in ASR.

FIG. 3A illustrates a digital audio file 304 being generated from an audio source 302 such as a microphone or tape recording. For example, a microphone captures sound waves generated by pressure variations in the air caused by a sound source. Inside the microphone, a transducer converts these sound waves into an electrical signal. A tape reader captures sound waves from a tape recording using a playback head to read magnetic variations on the tape that are converted into an electrical signal. These electrical signals represent the recorded sound and are recorded digitally to generate the digital audio file 304. Alternatively, the digital audio file is generated using audio creation software or a generative audio model rather than recorded audio being used.

FIG. 3B illustrates the digital audio file 304 being received by an encoder 307 of a language model 305 to result in an encoded time series 310. The encoder 307 determines values for any number of dimensions of the audio file for any number of time windows. For the time windows, the encoder provides a value for each dimension according to determined features of the sound such as the pitch (how high or low the sound is), the volume (how loud or soft it is), and the tone (the unique quality of the sound), power, waveform, etc. The encoder translates these features into numbers. These numbers represent different aspects of the sound in each time window. The encoder arranges these numbers into a grid or table such as the encoded time series 310. Rows in this grid represent features (e.g., k₁, k₂, k₃ . . . ,), and columns represent windows of time (e.g., t₀, t₁, t₂).

FIG. 3C illustrates normalizing the encoded time series 310 to result in a normalized encoded time series 320. In the example, the encoded time series 310 is represented by a matrix of values. Various methods of normalizing a matrix include group normalization, layer normalization, or normalization that occurs by rows and/or columns. Normalization rescales values into a common range, such as 0 to 1, making the numbers easier to compare. Similarly, normalizing by layer involves adjusting the numbers in each layer separately to fit within a common range. Further details and examples regarding normalization techniques are provided in Section 5 below.

FIG. 3D illustrates a first step of applying a convolution filter 325 to a padded, normalized time series matrix 325. In the example, a 3×3 convolution filter 323 is applied in a first iteration to the padded, normalized time series matrix 325. One or more rows and/or columns of zero padding are appended to the sides of the normalized time series 320 to produce a padded, normalized time series 325. In FIG. 3D, one layer of zero padding has been appended to the normalized time series 320 before the first row, before the first column, after the last row, and after the last column corresponding to the 3×3 size of the convolution filter 323. In other embodiments, a 5×5 convolution filter has two layers of zero padding appended before the first row, before the first column, after the last row, and after the last column of a normalized time series matrix, a 7×7 convolution filter has three layers of zero padding added, and so forth.

A set of values 327a are calculated for the first iteration using a first position for the convolution filter 323 corresponding to the first row and first column of the padded, normalized time series matric 325. Using the first position, a set of dot product values 327a are calculated for values of the convolution filter 323 and corresponding values of the padded, normalized encoded time series matrix 325. In the example, a sum value 329a is determined by summing the set of dot product values 327a resulting from the dot products of the values of the 3×3 convolution matrix and the corresponding values of the padded, normalized time series matrix 325. The sum value 329a is stored in a convolution filtered time series matrix 330 in a first cell 332 corresponding to the first position (i.e., at the first row and first column).

FIG. 3E illustrates a second step of an iterative process of applying the convolution filter to the normalized time series to result in a convoluted time series. As shown, the convolution filter 323 is applied in a position that is translated one row down relative to the padded, normalized time series matrix 325 as compared to the position shown in FIG. 3D. In the example, the process iterates for rows in the first column then proceeds to a next column. Alternatively, the process iterates for the columns in the first row and then proceeds to the next row.

The system computes a second set of dot products 327b determined by the dot product of values for the convolution filter 323 and corresponding values of the padded, normalized encoded time series matrix 325 using the translated position of the convolution filter 323. In the example, a second sum value 329b is calculated for the set of dot products 327b produced using the values of the 3×3 convolution matrix 323 and the corresponding values of the padded, normalized time series matrix 325 for the second, translated position. The second sum value 329b is stored in a second cell 334 of the convolution filtered time series matrix 330. Further iterations are repeated until the last row of the first column is reached, after which the process continues at the next column with the position of the convolution filter reset to the first row. The process is further iterated until the final row of the final column is reached. The sum values of the dot products resulting from the iterations of the process for the columns and rows are stored in the convolution filtered time series matrix 330 in corresponding columns and rows. In this way, corresponding dot product sum values are calculated for the cells of the normalized time series matrix 320 and stored in corresponding cells of the convolution filtered time series 330.

In various embodiments, a number of distinct convolution filters are used for the dimensions ‘kₙ,’ depending on the architecture parameters (i.e., embedding dimensionality) in the underlying architecture. The values of the convolution filters are learned by stochastic gradient descent and/or Adam optimization techniques that determines weights which maximize the average probability of results for the architecture matching a ground truth sequence. For example, the values of the convolution filters are learned by iteratively adjusting the filter weights to minimize the loss function for a particular feature, which measures the difference between the predicted output and the ground truth value for that feature. Stochastic gradient descent and Adam optimization techniques involve updating these weights by computing gradients of the loss function with respect to the weights and then modifying the weights in the direction that reduces the loss until an optimal set of weights is determined. Further details and examples regarding use of convolution filters and convolution filtering techniques are provided in Section 5 below.

FIG. 3F illustrates applying a ReLU nonlinearity function to the convoluted time series to result in a ReLU nonlinearized convoluted time series. The system applies the nonlinearity function to cells of the convolution filtered time series matrix 330 to result in a nonlinearized time series. In the example, the ReLU nonlinearity function is applied to cells of the convolution filtered time series matrix 330 to result in the ReLU nonlinearized, convolution filtered time series(s) 340. The system determines cells of the ReLU nonlinearized, convolution filtered time series(s) 340 by calculating a maximum of zero and a corresponding cell of the convolution filtered time series matrix 330. Further details regarding nonlinearity functions and the ReLU nonlinearity function and examples are provided in Section 5 below.

FIG. 3G illustrates adding the ReLU nonlinearized convoluted time series to the encoded time series to result in a residualized time series. In the example, cells of the ReLU nonlinearized, convolution filtered time series(s) 340 are added to corresponding cells of the normalized, encoded time series 310 to result in a residualized encoded time series 350. In embodiments, matrix addition is used to add the cells of the ReLU nonlinearized, convolution filtered time series(s) 340 to corresponding cells of the normalized, encoded time series 310. Further details about residualization techniques and examples are provided in Section 5 below.

FIG. 3H illustrates normalizing the residualized time series to result in a normalized residual time series (i.e., a modulation spectrum). In embodiments, layer normalization techniques are used on cells of the residualized time series matrix to determine corresponding normalized values. Other various normalization techniques include Min-Max Normalization; Z-Score Normalization; L1 or L2 Normalization (Vector Normalization), or other techniques. Further details and examples regarding normalization and layer normalization techniques are provided in Section 5 below.

FIG. 3I illustrates inputting the modulation spectrum into the decoder layer 309 to result in sound units such as tokens or phonemes. Language model decoders use time series data as input to generate decoded sound units as output. The decoder layer 309 uses the values e_norm(t,k) of the modulation spectrum 360 for the time frames (t₀, t₁, t₂) to determine set of decoded sound units 370 based on the features for a time frame [e.g. to determine n tokens for t_{0→n} based on (tₙ,k₁), (tₙ,k₂), (tₙ,k₃) . . . ]. The modulation spectrum input received by the decoder 309 improves the accuracy of decoded sound units produced by the language model 305.

### 5. Normalization, Convolution Filtration, Nonlinearization, and Residualization Techniques

In an example, encoded time series data output from an encoder is modified to generate input for a decoder, in accordance with one or more embodiments. The encoded time series data is represented in matrices with t rows and k columns, where t denotes several time frames, and k denotes an embedding dimensionality. An example is described as follows for a matrix having rows a, b, and c, columns 1, 2, and 3, and cells denoted a1, a2, a3, b1, b2, b3, c1, c2, c3. This example may be representative of operations although in practice there may be hundreds of rows and columns, or more or less rows or columns.

The system applies a normalization function to the encoded time series data. A normalization calculation for such a matrix of any size can be performed as follows. A row-wise average (mean) of the cells in each row is computed for the rows, such as for each or any row, row a, row b, and row c. A standard deviation is computed for the rows, such as for each or any row, row a, row b, and row c. Next, for each or any cell in the matrix, a value is calculated by using the value for the cell, subtracting the average (mean) for the corresponding row, and then dividing by the standard deviation for the corresponding row. The resulting values are stored in a matrix of normalized values. An average of the entire matrix can be computed. A standard deviation for the entire matrix can also be computed. For each cell in the matrix, a value is calculated by using the value for the cell, subtracting the average (mean) for the matrix, and then dividing by the standard deviation for matrix. The resulting values are stored in a matrix of normalized values.

Once normalization has completed, one or more convolution filters are applied to the matrix of normalized values, described below. A 3×3 convolution filter is applied to a 5×3 matrix of values computed using a standard deviation and normalization calculation as described herein. The example convolution matrix includes rows c1, c2, c3 and columns corresponding to the dimensionality of the time series data embeddings generated by the encoder and having a dimensionality index matching the matrix of normalized values. Extending the example, the convolution filter matrix in this example has columns 1, 2, 3.

Applying the convolution filter to the matrix of normalized values results in a matrix of dot product value sums. An example computation for one column of values resulting from the dot product sum is as follows: c1_1·0+c1_2·a1+c1_3·b1; c1_1·a1+c1_2·b1+c1_3·c1; c1_1·b1+c1_2·c1+c1_3·0. In this example, c1_1−c1_3 are used, representing a filter width of 3. The process is repeated for c₁ to cₙ for each k to yield a resulting modulation spectrum matrix. In various embodiments, this modulation spectrum matrix is normalized using a standard deviation and normalization technique, described above.

In typical conformer architecture, the outputs of convolution layers are input into a self-attention layer in the encoder. The self-attention layer takes a weighted average of the input features (an embedding) across the input speech sequence's length with weights that vary dynamically for the input sequences. This is due to the key and query dot products that vary with each input sequence in the self-attention mechanism. Therefore, the output of the convolution layers gets averaged over long and varying input sequences (such as a time series having 100 to 200 frames or more or less frames or a longer or shorter time series) and with varying weights.

One or more embodiments extend a layer of the Conformer architecture by explicitly computing a modulation spectrum of the Conformer's output hidden representation h(t, k) across the time dimension ‘t’ for over a window of W=15 frames on the spectral dimensions ‘k’. To compute modulation spectrum, a convolution filter is applied as described above at a depth-wise convolution layer after a Conformer layer.

The ith speech wav file's STFT sequence is denoted by Xi, and the ground truth word transcript is denoted as Yi. STFT spectrum features are denoted by Xi,t, where t denotes the tth short time Fourier spectrum feature. Also in this example, the sequence Xi input to a deep learning encoder for audio data in a training corpus. Example deep learning encoders include a transformer encoder, conformer encoder, or encoders for z Long Short-Term memory (LSTM), Recurrent Neural net (RNN), Convolutional Neural net (CNN), Feed forward neural net (FDNN), and/or the like.

The encoder's final layer's output is represented by h (t,k), where t denotes time frame, and k is the embedding dimensionality or the spectral component index. Typically, t={100, 200, 300} frames, and k=256 or 512, corresponding to the embedding dimensionality in the Conformer/Transformer or LSTM, RNN, CNN, FDNN architecture although these values could be greater or lesser.

The system passes h(t,k) via a LayerNorm layer, and its output is denoted hnorm(t,k). LayerNorm is a layer that performs layer wise normalization of its inputs and helps prevent vanishing or exploding gradients in the deep learning systems that are trained by stochastic gradient descent (SGD) or its variants as Adam optimizer. In this example, an Adam optimizer is used with a learning rate scheduler with a linear warmup phase to a maximum learning rate of typically 1e-5 and then an exponentially decaying learning rate.

$$h\_ \{ norm \} ( t , k ) = LayerNorm ( h ( t , k ) ) \qquad ( Eq 1 )$$

LayerNorm computes the mean of the given input sequence h(t,k) and its standard deviation. Next, it subtracts the mean (m) from the sample values in h(t,k) t={1,T} and k={1,K}, then divides it by its standard deviation (σ) as explained in the following equations:

$$m = {\sum }_{t = 1}^{T} {\sum }_{k = 1}^{K} h ( t , k ) / ( T * K ) \qquad ( Eq 2 )$$

$$σ = \sqrt{( {\sum }_{t = 1}^{T} {\sum }_{k = 1}^{K} {( h ( t , k ) - m )}^{2} / ( T * K ) )} \qquad ( Eq 3 )$$

h_{norm(t,k)} is obtained as follows,

$${h}_{norm ( t , k )} = ( {h}_{( t , k )} - m ) / ( σ ) \qquad ( Eq 4 )$$

For a particular k, a distinct 1-dim convolution filter Ck is used, called depth-wise convolution in deep learning. This filter convolves the input hnorm(t,k) across the dimension ‘t’ with a width of W.

In the example, Ck consists of W weights, where ‘W’ is kept constant for the speech sequences. A value of W is chosen empirically, so it gives highest accuracy on a dev set and is typically in the range W={5, 100}. In the example, W=15 is used, but the value for W can vary from dataset to dataset and can be empirically tuned to increase accuracy.

The output of the kth convolution filter Ck is denoted g(t,k) and is defined in the following relationship of Eq. 5. In this case, g(t,k) represents the output of the modulation spectrum filter whose finite impulse response (FIR) is given by the convolution filter weights Cₖ(i), where i∈(1, W), and k∈(1, K). Also, ‘k’ represents the embedding dimension index of the speech encoder's normalized last layer, i.e., hnorm(t,k), and C_k (i) denotes the weights of the k\hat{ }th convolution filter, i∈(1,W}.

$$g ( t , k ) = {\sum }_{i = 1}^{W} {h}_{norm} ( t - i , k ) {C}_{k} ( i ) \qquad ( Eq 5 )$$

A ReLU non-linearity function is applied to the output of the modulation filter g(t,k). A residual connection is added as shown in Eq 6a and Eq 6b. This ensures the gradients can propagate to the lower layers, and they do not vanish (i.e., become zero) during gradient descent-based training.

$$f ( t , k ) = Relu ( g ( t , k ) ) \qquad ( Eq 6 a )$$

$$where Relu ( x ) = x if x \geq 0$$

$$Relu ( x ) = 0 if x < 0$$

$$e ( t , k ) = f ( t , k ) + {h}_{norm} ( t , k ) \qquad ( Eq 6 )$$

Next, e(t,k) is used as input to a final layer norm layer that computes a normalization according to Eq 2. The normalized output of the final norm layer is denoted as enorm(t,k). This results in the following relationship:

$${e}_{norm} ( t , k ) = LayerNorm ( e ( t , k ) ) \qquad ( Eq 7 )$$

Next in the example, enorm(t,k) is input to the Conformer/Transformer decoder (or any other decoder such as LSTM decoder or Convolutional decoder or simple CTC based decoder).

As can be seen from Eq 1, the W filter weights, i.e., C_k(1), C_k(2), . . . C_k(W), correspond to the impulse response of the modulation spectrum filter C_k, corresponding to the embedding dimension ‘k’. Distinct filters are used for the dimensions ‘k,’ where k=256 or k=512, depending on the architecture parameters (i.e., embedding dimensionality) in the underlying Conformer/Transformer/LSTM/RNN/CNN architecture.

In Transformer/Conformer architectures, a self-attention layer is computed as a weighted average of the input embeddings. However, the weights computed by the self-attention layer change dynamically even when performing inferencing (i.e., after the model training), depending on the input embeddings/spectral features.

In contrast, using a modulation filter/convolution layer, the width ‘W’ of these filters C_k is kept constant for the speech utterances, and their weights are learned by stochastic gradient descent or Adam optimization. After the model training, the learned modulation filter weights C_k are kept constant. The encoder's output h (t,k) is filtered using a modulation spectrum filter with these learned weights. The impulse response of the modulation spectrum filter C_k is given by its weights, i.e., C_k(1), C_k(2), . . . C_k(W). Furthermore, these weights are learned in a discriminative way by the overall Stochastic Gradient Descent (SGD) and/or Adam optimizer or similar gradient descent algorithm to maximize the probability of the ground truth sub word units' sequence, i.e., Yi, where (Xi, Yi) denotes the ith training example in the corpus. Here, Xi denotes the input speech STFT, and Yi denotes the ground truth sub word units' sequence.

For example, if an input speech signal Xi has the transcript, “This is a cat”, then Yi could be represented by the sequence of characters Yi={<s> ‘T’, ‘h’, ‘i’, ‘s’, ‘ ’, ‘i’, ‘s’, ‘ ’, ‘a’, ‘ ’, ‘c’, ‘a’, ‘t’, </s>}, where ‘ ’ denotes a blank symbol, <s> denotes start of sentence, and </s> denotes end of sentence. Apart from the above character units, other sub word units, such as sentence-piece units or byte-pair units, can be used.

In this embodiment, the encoder and decoder parameters are denoted by θ_{enc} and θ_{dec}, respectively. Also in this example, modulation spectrum filter parameters (i.e., convolution filter weights) are denoted as Cₖ(t)k∈1, K, t∈1, W. Parameters may be initially learned via a gradient descent algorithm, such as SGD or Adam optimizer or similar gradient descent algorithm, which maximizes the average probability of a ground truth sequence Yi as estimated.

An input STFT Xi is used, where an average is performed over speech training examples (Xi, Yi). In this example, the speech training examples in the training corpus are numbered i={1,I}. Decoder outputs of the encoder/decoder model estimate the probability P(Yᵢ|Xᵢ, θ_{enc}, θ_{dec}, Cₖ(t)) of the ground truth sequence Yi given the input STFT Xi and the model parameters θ_{enc}, θ_{dec}, Cₖ(t).

$${θ}_{enc} , {θ}_{dec} , {C}_{k} ( t ) = arg max {\sum }_{i = 1}^{I} P ( {Y}_{i} \vert {X}_{i} , {θ}_{enc} , {θ}_{dec} , {C}_{k} ( t ) ) \qquad ( Eq 8 )$$

Extraction of modulation spectrum filtered output g(t,k) is performed using modulation filter Ck(t) t={1, W} from a deep learning encoder's output h (t,k). The speech encoder can be any of the following encoders: Transformer, Conformer, LSTM, RNN, CNN, or Feed-forward neural net encoder. The signal g(t,k) is processed by various layers such as LayerNorm or ReLU, and a residual connection is added followed by another LayerNorm. The resulting signal, e_norm(t,k), is input to the deep learning decoder.

A library known as the Wenet library is used in an example to train a baseline Conformer model for speech recognition. In the example, nine hundred sixty hours of LibriSpeech training data are used, and improved work error rates on test sets are reported. Test sets may include test-clean, test_other, dev_clean, dev_other.

A conformer and modulation spectrum model system is trained to compute the modulation spectrum y (t,k) from an output h (t,k) of a final Conformer layer of the baseline conformer, where k=256, and t denotes the time frames. The number of parameters in both the baseline system and the conformer and modulation system are almost the same, for example, approximately 39*10\hat{ }6 parameters. Adding the modulation spectrum layer to the baseline conformer uses very few parameters, for example, k*W, where W=15. Both the baseline system and the conformer and modulation system were trained up to 70 epochs and then evaluated for their word error rate (WER) on the four test-sets. The results for the conformer with modulation spectrum demonstrated improvement over a baseline Conformer in various conditions.

### 6. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, data storage, a virtual machine, a container, and/or a software application. Network resources are shared amongst multiple clients. Clients request computing services from a computer network independently of each other. Network resources are dynamically assigned to the requests and/or clients on an on-demand basis.

Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides the speech recognition model via a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment versions of a speech recognition model may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QOS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally, or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets received from the source device are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 7. Microservice Applications

According to one or more embodiments, the techniques described herein are implemented in a microservice architecture. A microservice in this context refers to software logic designed to be independently deployable, having endpoints that may be logically coupled to other microservices to build a variety of applications. For example, a microservice may have a modulation spectrum-based ASR model logically coupled to a software logic endpoint. Applications built using microservices are distinct from monolithic applications, which are designed as a single fixed unit and generally comprise a single logical executable. With microservice applications, different microservices are independently deployable as separate executables. Microservices may communicate using HyperText Transfer Protocol (HTTP) messages and/or according to other communication protocols via API endpoints. Microservices may be managed and updated separately, written in different languages, and be executed independently from other microservices.

Microservices provide flexibility in managing and building applications. Different applications may be built by connecting different sets of microservices without changing the source code of the microservices. Thus, the microservices act as logical building blocks that may be arranged in a variety of ways to build different applications. Microservices may provide monitoring services that notify a microservices manager (such as If-This-Then-That (IFTTT), Zapier, or Oracle Self-Service Automation (OSSA)) when trigger events from a set of trigger events exposed to the microservices manager occur. Microservices exposed for an application may additionally, or alternatively, provide action services that perform an action in the application (controllable and configurable via the microservices manager by passing in values, connecting the actions to other triggers and/or data passed along from other actions in the microservices manager) based on data received from the microservices manager. The microservice triggers and/or actions may be chained together to form recipes of actions that occur in optionally different applications that are otherwise unaware of or have no control or dependency on each other. These managed applications may be authenticated or plugged in to the microservices manager, for example, with user-supplied application credentials to the manager, without requiring reauthentication each time the managed application is used alone or in combination with other applications.

In one or more embodiments, microservices may be connected via a GUI. For example, microservices may be displayed as logical blocks within a window, frame, or other element of a GUI. A user may drag and drop microservices into an area of the GUI used to build an application. The user may connect the output of one microservice into the input of another microservice using directed arrows or any other GUI element. The application builder may run verification tests to confirm that the output and inputs are compatible (e.g., by checking the datatypes, size restrictions, etc.)

### Triggers

The techniques described above may be encapsulated into a microservice, according to one or more embodiments. In other words, a microservice may trigger a notification (into the microservices manager for optional use by other plugged-in applications, herein referred to as the “target” microservice) based on the above techniques and/or may be represented as a GUI block and connected to one or more other microservices. The trigger condition may include absolute or relative thresholds for values, and/or absolute or relative thresholds for the amount or duration of data to analyze, such that the trigger to the microservices manager occurs whenever a plugged-in microservice application detects that a threshold is crossed. For example, a user may request a trigger into the microservices manager when the microservice application detects a value has crossed a triggering threshold.

In one embodiment, the trigger, when satisfied, might output data for consumption by the target microservice. In another embodiment, the trigger, when satisfied, outputs a binary value indicating the trigger has been satisfied or outputs the name of the field or other context information for which the trigger condition was satisfied. Additionally or alternatively, the target microservice may be connected to one or more other microservices such that an alert is input to the other microservices. Other microservices may perform responsive actions based on the above techniques, including, but not limited to, deploying additional resources, adjusting system configurations, and/or generating GUIs.

### Actions

In one or more embodiments, a plugged-in microservice application may expose actions to the microservices manager. The exposed actions may receive, as input, data or an identification of a data object or location of data, that causes data to be moved into a data cloud.

In one or more embodiments, the exposed actions may receive, as input, a request to increase or decrease existing alert thresholds. The input might identify existing in-application alert thresholds and whether to increase or decrease or delete the threshold. Additionally, or alternatively, the input might request the microservice application to create new in-application alert thresholds. The in-application alerts may trigger alerts to the user while logged into the application or may trigger alerts to the user using default or user-selected alert mechanisms available within the microservice application itself, rather than through other applications plugged into the microservices manager.

In one or more embodiments, the microservice application may generate and provide an output based on input that identifies, locates, or provides historical data, and defines the extent or scope of the requested output. The action, when triggered, causes the microservice application to provide, store, or display the output, for example, as a data model or as aggregate data that describes a data model.

### 8. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

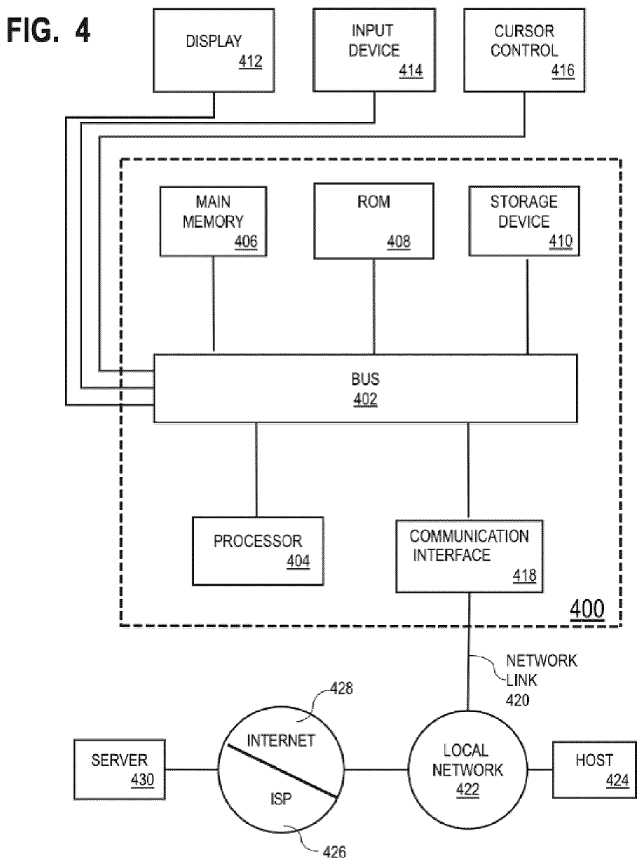

For example, FIG. 4 is a block diagram that illustrates a computer system 400 upon which an embodiment of the disclosure may be implemented. Computer system 400 includes a bus 402 or other communication mechanism for communicating information, and a hardware processor 404 coupled with bus 402 for processing information. Hardware processor 404 may be, for example, a general-purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions. One or more embodiments include a computer program product with instructions to perform the operations as described herein. One or more embodiments include transitory storage media, transmitted over a wireless or wired connection, with instructions to perform the operations as described herein.

Computer system 400 further includes a read only memory (ROM) 408 or other static storage device coupled to bus 402 for storing static information and instructions for processor 404. A storage device 410, such as a magnetic disk, optical disk, or a Solid State Drive (SSD) is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic, or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic, or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 440 might transmit a requested code for an application program through Internet 428, ISP 426, local network 422 and communication interface 418.

The received code may be executed by processor 404 as it is received, and/or stored in storage device 410, or other non-volatile storage for later execution.

### 9. Miscellaneous; Extensions; Other Considerations

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. One or more non-transitory computer readable media comprising instructions which, when executed by one or more hardware processors, cause performance of operations comprising:
accessing encoded time series data generated by an encoder of a speech recognition model;
applying at least a convolution filter to the encoded time series data to generate a modulation spectrum; and
inputting the modulation spectrum to a decoder of the speech recognition model.

2. The non-transitory media of claim 1, wherein
the encoded time series data comprises a plurality of time frames each having a dimensionality; and
applying the convolution filter to the encoded time series data comprises computing a plurality of dot products of values of columns of a convolution matrix and values of columns of a normalized matrix of feature values indexed by time frame and dimension.

3. The non-transitory media of claim 2, wherein the convolution filter uses a filter width between five (5) and twenty-five (25), a number of time frames between fifty (50) and five hundred (500), and an embedding dimensionality matching a dimensionality of an architecture of the speech recognition model.

4. The non-transitory media of claim 1, wherein the operations further comprise applying a ReLU nonlinearity function to an output of the convolution filter to obtain a ReLU nonlinearity result, and wherein the modulation spectrum is generated based at least in part on the ReLU nonlinearity result.

5. The non-transitory media of claim 1, wherein the operations further comprise, prior to applying the convolution filter to the encoded time series data: applying a normalization function to the encoded time series data.

6. The non-transitory media of claim 1, wherein the operations further comprise:
applying a normalization function to the modulation spectrum.

7. The non-transitory media of claim 1 wherein the operations further comprise residually connecting the encoded time series data to the modulation spectrum.

8. The non-transitory media of claim 1, wherein
the encoded time series data comprises a plurality of time frames; and
the operations comprise applying a normalization function to the encoded time series data by:
generating a matrix for the encoded time series data, the matrix comprising a plurality of rows indexed by time frame and a plurality of columns indexed by dimension;
for each cell of the matrix for the encoded time series data, performing matrix operations on the cell to determine a normalized value by: subtracting a mean value for the matrix from a cell value for the cell to obtain a corresponding result; dividing the corresponding result by a standard deviation value for the matrix to obtain the normalized value; and
storing the normalized value in a corresponding matrix cell.

9. The non-transitory media of claim 1 wherein the instructions further cause performance of operations comprising:
decoding the modulation spectrum at the decoder; and
outputting one or more subword units from the decoder.

10. A method comprising:
accessing encoded time series data generated by an encoder of a speech recognition model;
applying at least a convolution filter to the encoded time series data to generate a modulation spectrum; and
inputting the modulation spectrum to a decoder of the speech recognition model,
wherein the method is performed by at least one device including a hardware processor.

11. The method of claim 10, wherein
the encoded time series data comprises a plurality of time frames each having a dimensionality; and
applying the convolution filter to the encoded time series data comprises computing a plurality of dot products of values of columns of a convolution matrix and values of columns of a normalized matrix of feature values indexed by time frame and dimension.

12. The method of claim 11, wherein the convolution filter uses a filter width between five (5) and twenty-five (25), a number of time frames between fifty (50) and five hundred (500), and an embedding dimensionality matching a dimensionality of an architecture of the speech recognition model.

13. The method of claim 10, wherein the method further comprises applying a ReLU nonlinearity function to an output of the convolution filter to obtain a ReLU nonlinearity result, and wherein the modulation spectrum is generated based at least in part on the ReLU nonlinearity result.

14. The method of claim 10, wherein the method further comprises, prior to applying the convolution filter to the encoded time series data: applying a normalization function to the encoded time series data.

15. The method of claim 10, wherein the method further comprises: applying a normalization function to the modulation spectrum.

16. The method of claim 10, wherein the method further comprises residually connecting the encoded time series data to the modulation spectrum.

17. The method of claim 10, wherein
the encoded time series data comprises a plurality of time frames; and
the method comprises applying a normalization function to the encoded time series data by:
generating a matrix for the encoded time series data, the matrix comprising a plurality of rows indexed by time frame and a plurality of columns indexed by dimension;
for each cell of the matrix for the encoded time series data, performing matrix operations on the cell to determine a normalized value by: subtracting a mean value for the matrix from a cell value for the cell to obtain a corresponding result; dividing the corresponding result by a standard deviation value for the matrix to obtain the normalized value; and
storing the normalized value in a corresponding matrix cell.

18. The method of claim 10, wherein the method further comprises:
decoding the modulation spectrum at the decoder; and
outputting one or more subword units from the decoder.

19. A system comprising:
at least one device including a hardware processor;
the system being configured to perform operations comprising:
accessing encoded time series data generated by an encoder of a speech recognition model;
applying at least a convolution filter to the encoded time series data to generate a modulation spectrum; and
inputting the modulation spectrum to a decoder of the speech recognition model.

20. The system of claim 19, wherein
the encoded time series data comprises a plurality of time frames each having a dimensionality; and
applying the convolution filter to the encoded time series data comprises computing a plurality of dot products of values of columns of a convolution matrix and values of columns of a normalized matrix of feature values indexed by time frame and dimension.
